(19) United States
(12) Patent Application Publication
(10) Pub. No.: US 2013/0294863 A1
(43) Pub. Date: Nov. 7, 2013

(54) FLOATING FASTENER

(71) Applicant: Ying-Chih TSENG, New Taipei City (TW)

(72) Inventor: Ying-Chih TSENG, New Taipei City (TW)

(73) Assignee: HANWIT PRECISION INDUSTRIES LTD., New Taipei City (TW)

(21) Appl. No.: 13/461,548

(22) Filed: May 1, 2012

(51) Int. Cl. F16B 39/282

(52) U.S. Cl. 411/175

(57) ABSTRACT

A floating fastener includes a mounting base member bonded to a first panel member and having a partition wall dividing an inside space thereof into an upper chamber and a bottom chamber and a screw hole located at the center of the partition wall, a lock screw having a stepped head, a shank extended from the stepped head and inserted through the screw hole and terminating in a threaded locking tip, a cap member affixed to the stepped head and axially movably coupled to the mounting base member, and a spring member sleeved onto the shank of the lock screw and stopped between the stepped head of the lock screw and the partition wall of the mounting base member for allowing the lock screw to be moved in and out of the mounting base member for detachably locking the first panel member to a second panel member.

### BACKGROUND OF THE INVENTION

1. Field of the Invention:

The present invention relates to fastener means for joining two metal panel members and more particularly, to a floating fastener, which comprises a mounting base member for bonding to a first panel member, a lock screw detachably mounted in the mounting base member, a cap member affixed to the lock screw and axially slidably coupled to the mounting base member, and a spring member supporting the lock screw in the mounting base member for allowing the lock screw to be moved in and out of the mounting base member for detachably locking the first panel member to second panel member.

2. Description of the Related Art:

When joining panel members, fastening devices respectively formed of a lock screw, a rotary knob and a washer may be used. During application, the lock screw, rotary knob and washer of each fastening device are assembled and then mounted at a first panel member. When fastening the first panel member to a second panel member, rotate the rotary knob of each fastening device to drive the respective lock screw into a respective mounting screw hole at the second panel member, and then use a hand tool to fasten tight the lock screw. This multiple panel member fastening method can be used in a machine tool or other situations where multiple panel members are to be fastened in a stack. In a machine tool, the location where panel members are fastened together may be at the power drive or speed-adjustment unit inside the housing. The lock screws of the fastening devices may fall from the panel members and be missed easily due to user's negligence during a panel member dismounting procedure for the performance of a repair or speed adjustment operation, affecting further re-installation operation.

To avoid the aforesaid problem, a captive screw formed of a knob, a spring member, a barrel and a lock screw may be used. During installation, the barrel is bonded to a mounting through hole on a first panel member, and then the knob is rotated to drive the screw into a mounting screw hole on a second panel member. After disconnection of the screw from the mounting screw hole of the second panel member, the first panel member can be removed from the second panel member, and the captive screw is kept secured to the panel member, avoiding missing the component parts. According to this design, the knob, barrel and lock screw of the captive screw are made of metal. After accommodation of the head of the lock screw in an accommodation chamber of the knob, a tool must be used to crimp the knob, affixing the knob to the head of the lock screw. This installation procedure is complicated, wasting much time and labor. Further, the knob must be accurately crimped, avoiding damage or installation failure. To avoid this problem, a plastic knob may be used and directly molded on the head of the lock screw by an insert molding process. A plastic knob can be made in any of a variety of shapes to provide a colorful design. Further, a plastic knob has damp proof and corrosion proof features. However, when bonding the barrel of the captive screw to a mounting through hole of a panel member with a solder paste using a reflow soldering process, the knob may fade in heat or may be permanently deformed or burned out, and the spring member may be tempered, lowering the structural strength or leading to structural break.

Therefore, an improvement in this regard is necessary.

### SUMMARY OF THE INVENTION

The present invention has been accomplished under the circumstances in view. It is therefore the main object of the ₚresent invention to provide a floating fastener, which facilitates quick installation for detachably joining panel members, avoiding structural damage during installation.

To achieve this and other objects of the present invention, a floating fastener comprises a mounting base member and a locking device. The mounting base member comprises a partition wall transversely disposed therein and dividing an inside space thereof into an upper chamber and a bottom chamber, a screw hole located at the center of the partition wall in communication between the upper chamber and the bottom chamber, a top flange extending around the periphery thereof at a top side, and a flanged bottom bonding portion disposed at the bottom side thereof around the bottom chamber and adapted for bonding to a mounting through hole of a first panel member. The locking device is adapted for detachably fastening to a mounting screw hole of a second panel member to lock the first panel member and the second panel member. The locking device comprises a cap member, a lock screw and a spring member. The cap member comprises an accommodation open chamber, a locating groove extending around an inside wall thereof within the accommodation open chamber, and a grip disposed at a top side thereof. The lock screw comprises a stepped head fixedly fastened to the locating groove of the cap member, a shank perpendicularly extended from a flat bottom wall of the stepped head and inserted through the screw hole of the mounting base member and terminating in a threaded locking tip. The spring member is sleeved onto the shank of the lock screw and stopped between the stepped head of the lock screw and the partition wall of the mounting base member for allowing the lock screw to be moved axially in and out of the mounting base member to lock or unlock the second panel member.

Further, the cap member comprises an inside flange disposed at a bottom side thereof and slidably coupled to the periphery of the mounting base member between the top flange and flanged bottom bonding portion. Further, the cap member provides a grip that can be formed of two finger lugs or a broad brim. Through the grip, a user can rotate the cap member and the lock screw conveniently with less effort to fasten the first panel member to the second panel member, or to unfasten the first panel member from the second panel member for a repair work or replacement of electronic components.

### BRIEF DESCRIPTION OF THE DRAWINGS

FIG. 1 is an oblique top elevational view of a floating fastener in accordance with the present invention.

FIG. 2 is an exploded view of the floating fastener in accordance with the present invention.

FIG. 3 is another exploded view of the floating fastener in accordance with the present invention when viewed from another angle.

FIG. 4 is a sectional exploded view of the floating fastener in accordance with the present invention after installation of the mounting base member in a mounting through hole of a first panel member.

FIG. 5 is a schematic sectional side view of the present invention, illustrating the floating fastener installed in the first panel member and the first panel member kept above a second panel member.

FIG. 6 corresponds to FIG. 5, illustrating the first panel member attached to the second panel member and the locking tip of the lock screw driven into a corresponding mounting screw hole in the second panel member.

FIG. 7 is an oblique top elevational view of an alternate form of the floating fastener in accordance with the present invention.

FIG. 8 is a schematic applied view of the present invention.

### DETAILED DESCRIPTION OF THE PREFERRED EMBODIMENT

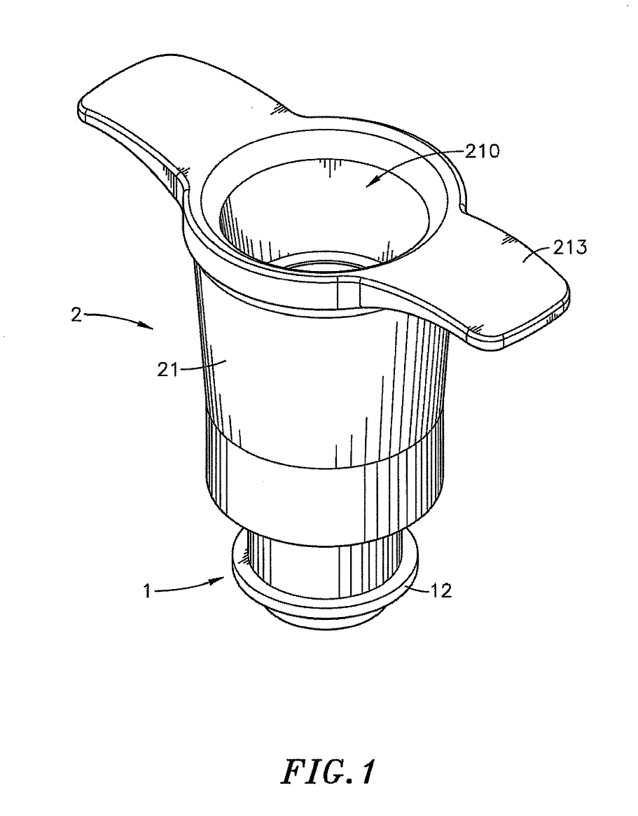

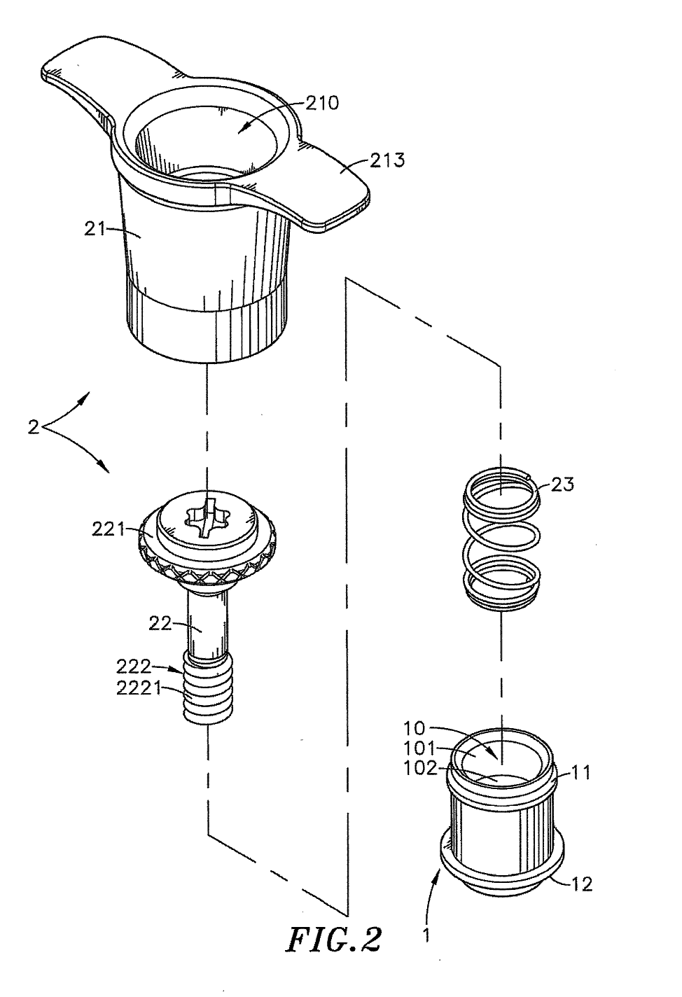

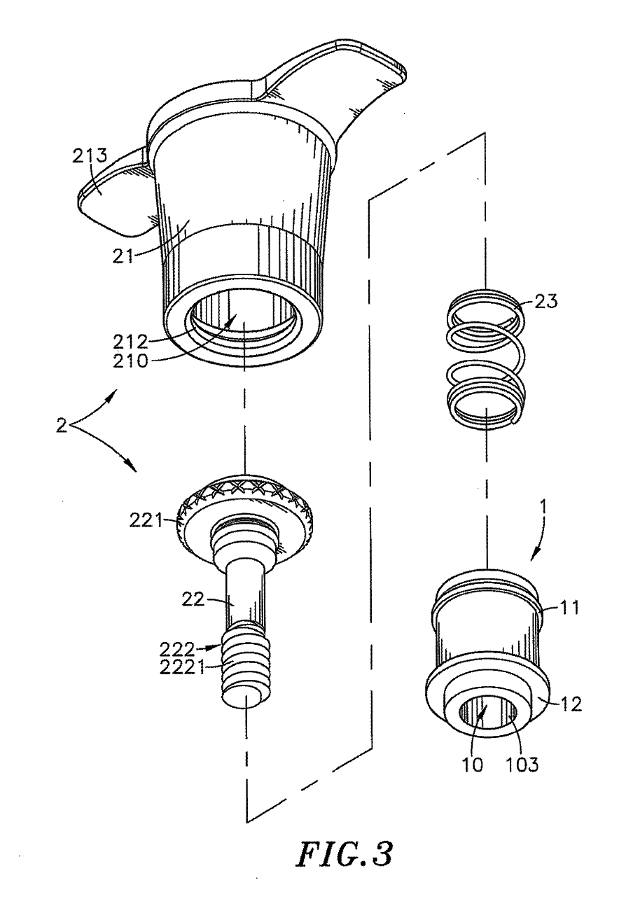

Referring to FIGS. 1, 2 and 3, a floating fastener in accordance with the present invention is shown. The floating fastener comprises a mounting base member 1, and a locking device 2.

The mounting base member 1 is an open-ended cylindrical member comprising a partition wall 102 transversely disposed therein on the middle and dividing the inside space 10 thereof into an upper chamber 101 and a bottom chamber 103, a screw hole 1021 located at the center of the partition wall 102 in communication between the upper chamber 101 and the bottom chamber 103, a top flange 11 extending around the periphery thereof at a top side, and a flanged bottom bonding portion 12 disposed at the bottom side thereof around the bottom chamber 103.

The locking device 2 comprises a cap member 21, a lock screw 22, and a spring member 23. The cap member 21 is a plastic member affixed to a stepped head 221 of the lock screw 21, comprising an accommodation open chamber 210, a locating groove 211 extending around the inside wall thereof within the accommodation open chamber 210, an inside flange 212 protruded from the inside wall and disposed at a bottom side in the accommodation open chamber 210, and a grip 213 disposed at the top side of the cap member 21 far from the inside flange 212. In this embodiment, the grip 213 is formed of two finger lugs respectively outwardly extended from the top edge of the cap member 21 at two opposite sides. The lock screw 22 comprises the stepped head 221 fixedly fastened to the locating groove 211 of the cap member 21, a shank 222 perpendicularly extended from the flat bottom wall of the stepped head 221 and terminating in a threaded locking tip 2221 that suspends outside the cap member 21. The spring member 23 is sleeved onto the shank 222 of the lock screw 22, having its one end stopped against the stepped head 221 of the lock screw 22 and its other end thereof inserted into the upper chamber 101 of the mounting base member 1 and stopped against the partition wall 102 of the mounting base member 1.

When assembling the mounting base member 1 and the locking device 2, insert the lock screw 22 into the upper chamber 101 of the mounting base member 1 and driving the threaded locking tip 2221 of the lock screw 22 into the screw hole 1021 of the mounting base member 1, and then continuously rotate the locking device 2 to let the threaded locking tip 2221 of the lock screw 22 pass through the screw hole 1021 of the mounting base member 1, and then impart a downward pressure to the cap member 21 to move the inside flange 212 of the cap member 21 downwardly over the top flange 11 of the mounting base member 1. Subject to the elastic material property of the plastic cap member 21, the inside flange 212 of the cap member 21 can be elastically deformed and moved over the top flange 11 of the mounting base member 1. After passed over the top flange 11 of the mounting base member 1, the inside flange 212 of the cap member 21 immediately returns to its former shape. At this time, the inside flange 212 of the cap member 21 can be moved axially along the outside wall of the mounting base member 1 between the top flange 11 and the flanged bottom bonding portion 12, and the spring member 23 is stopped between the stepped head 221 of the lock screw 22 and the partition wall 102 of the mounting base member 1, i.e., the locking device 2 is floatably supported in the mounting base member 1.

Further, the upper chamber 101 of the mounting base member 1 has a greater diameter than the bottom chamber 103 but a shorter depth than the bottom chamber 103. Thus, the spring member 23 can be accommodated in the top chamber 101 of the mounting base member 1 and the accommodation open chamber 210 of the cap member 21. When a user forces the cap member 21 downwards to compress the spring member 23 against the partition wall 102 of the mounting base member 1 and to hold the spring member 23 in the compressed condition, the threaded locking tip 2221 of the lock screw 22 will be held outside the bottom chamber 103 of the mounting base member 1.

Further, the cap member 21 and lock screw 22 can be made in integrity, i.e., the plastic cap member 21 can be directly molded on the stepped head 221 of the lock screw 22.

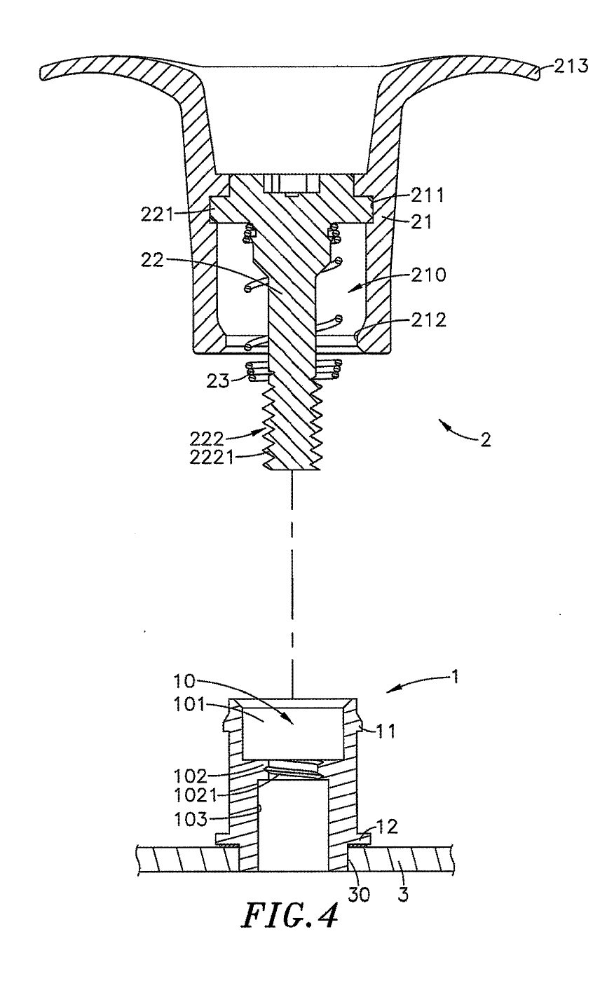

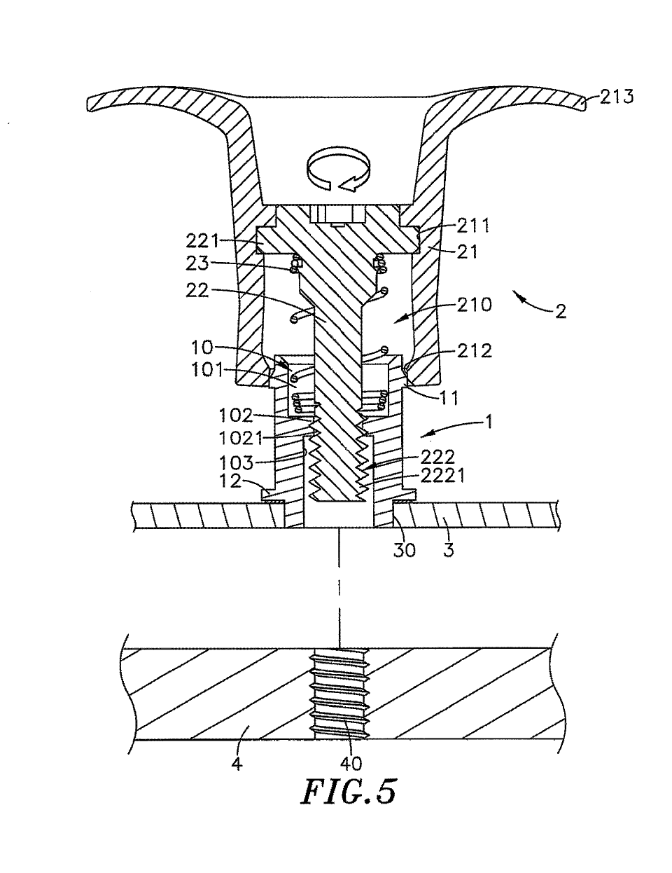

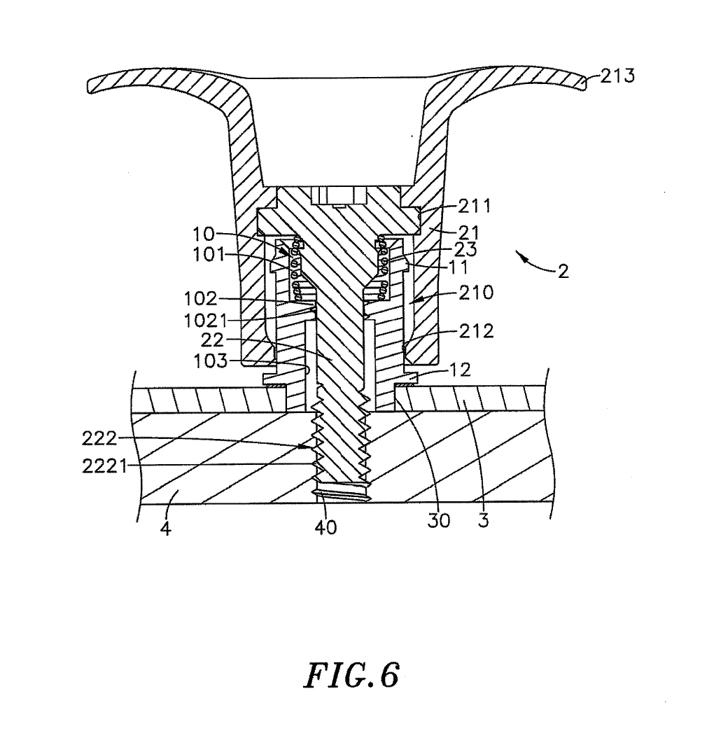

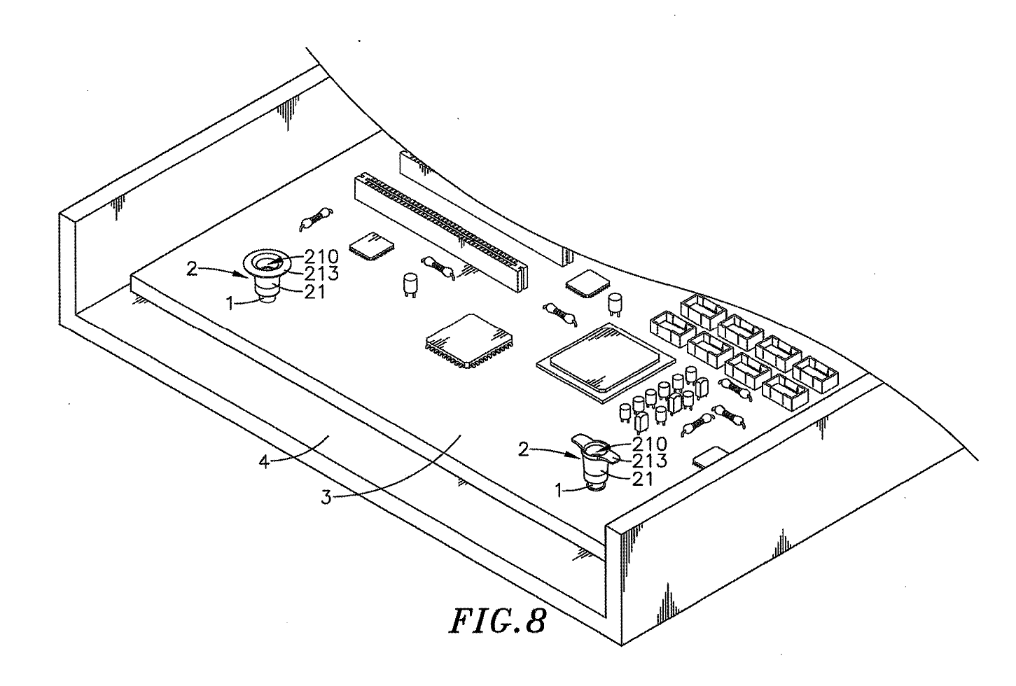

Referring to FIGS. 4, 5 and 6, the floating fastener is installed in a mounting through hale 30 of a first panel member 3 and detachably fastened to a mounting screw hole 40 of a second panel member 4 to lock the first panel member 3 and the second panel member 4 in a stacked condition. When installing the floating fastener in the first panel member 3, insert the flanged bottom bonding portion 12 of the mounting base member 1 into the mounting through hole 30 of the first panel member 3 before coupling the locking device 2 to the mounting base member 1, and then employ a reflow soldering process to bond the flanged bottom bonding portion 12 of the mounting base member 1 to the first panel member 3 with a solder paste. After bonding of the mounting base member 1 to the first panel member 3, sleeve the spring member 23 onto the threaded shank 222 of the lock screw 22, and then rotate the cap member 22 of the locking device 2 to thread the threaded locking tip 2221 of the lock screw 22 into the screw hole 1021 of the mounting base member 1, and then continuously rotate the locking device 2 to let the threaded locking tip 2221 of the lock screw 22 pass through the screw hole 1021 of the mounting base member 1 into the bottom chamber 103 and to force the inside flange 212 of the cap member 21 downwardly over the top flange 11 of the mounting base member 1. At this time, the inside flange 212 of the cap member 21 can be moved axially along the outside wall of the mounting base member 1 between the top flange 11 and the flanged bottom bonding portion 12, and the spring member 23 is stopped between the stepped head 221 of the lock screw 22 and the partition wall 102 of the mounting base member 1 to force the lock screw 22 and the cap member 21 upwards relative to the mounting base member 1, enabling the inside flange 212 of the cap member 21 to be stopped at the bottom side of the top flange 11 of the mounting base member 1. Thus, the floating fastener is floatably supported in the mounting base member 1 at the first panel member 3. At this time, the first panel member 3 can be attached to the second panel member 4 to keep the mounting through hole 30 in axial alignment with mounting screw hole 40 of a second panel member 4, and the threaded locking tip 2221 of the lock screw 22 can be driven into the mounting screw hole 40 of a second panel member 4 to lock the first panel member 3 to the second panel member 4. Further, as shown in FIG. 8, the first panel member 3 can be a circuit board, and the second panel member 4 can be a panel of a machine case.

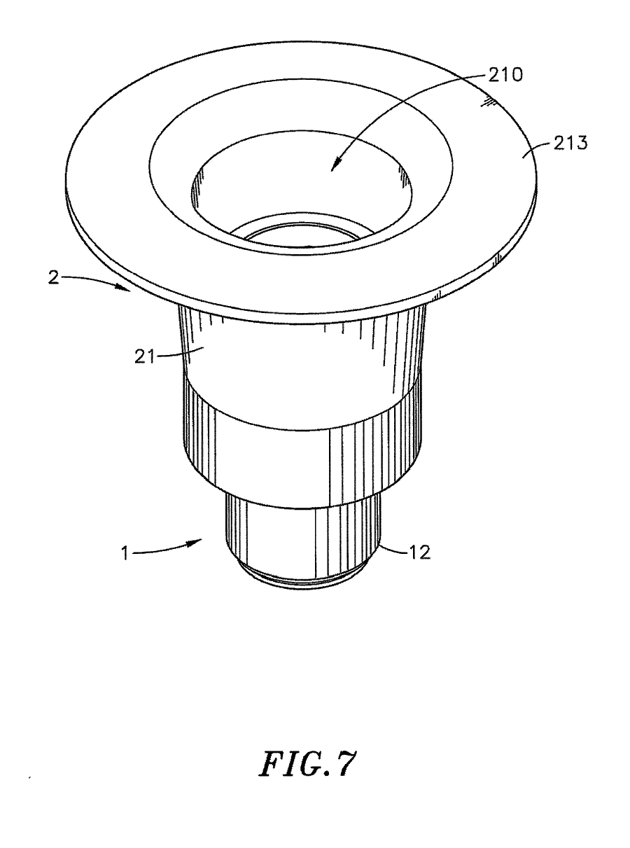

Referring to FIG. 7, an oblique top elevation of an alternate form of the floating fastener is shown. This alternate form is substantially similar to the embodiment shown in FIGS. 1-6 with the exception of the design of the grip 213. According to this alternate form, the grip 213 is a broad brim extending around the top edge of the periphery of the cap member 21. Through the grip 213, a user can rotate the cap member 21 and the lock screw 22 conveniently with less effort to fasten the first panel member (circuit board) 3 to the second panel member (machine case) 4, or to unfasten the first panel member (circuit board) 3 from the second panel member (machine case) 4 for a repair work or replacement of electronic components.

In conclusion, the invention provides a floating fastener, which has features and advantages as follows:
1. By means of the flanged bottom bonding portion 12, the mounting base member 1 of the floating fastener can be bonded to the mounting through hole 30 of the first panel member 3 by a reflow soldering process before installation of the locking device 2, avoiding quality deterioration, softening or color fading of the component parts of the locking device and prolonging their lifespan.
2. After bonding of the mounting base member 1 of the floating fastener can be bonded to the mounting through hole 30 of the first panel member 3, the threaded locking tip 2221 of the lock screw 22 is suspending in the bottom chamber 103 below the screw hole 1021 of the mounting base member 1, the spring member 23 is stopped between the stepped head 221 of the lock screw 22 and the partition will 102 of the mounting base member 1, and the inside flange 212 of the cap member 21 is movable axially along the outside wall of the mounting base member 1 between the top flange 11 and the flanged bottom bonding portion 12, and therefore, the locking device 2 can be moved axially in and out of the mounting base member 1 and will not fall out of the mounting base member 1.
3. The cap member 21 provides a grip 213 that can be formed of two finger lugs or a broad brim. Through the grip 213, a user can rotate the cap member 21 and the lock screw 22 conveniently with less effort to fasten the first panel member (circuit board) 3 to the second panel member (machine case) 4, or to unfasten the first panel member (circuit board) 3 from the second panel member (machine case) 4 for a repair work or replacement of electronic components.

A prototype of floating fastener has been constructed with the features of FIGS. 1-8. The floating fastener functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A floating fastener, comprising:
a mounting base member comprising a partition wall transversely disposed therein and dividing an inside space thereof into an upper chamber and a bottom chamber, a screw hole located at the center of said partition wall in communication between said upper chamber and said bottom chamber, a top flange extending around the periphery thereof at a top side, and a flanged bottom bonding portion disposed at a bottom side thereof around said bottom chamber and adapted for bonding to a mounting through hole of a first panel member; and
a locking device mounted in said mounting base member and adapted for detachably fastening to a mounting screw hole of a second panel member to lock said first panel member and said second panel member, said locking device comprising a cap member, a lock screw and a spring member, said cap member comprising an accommodation open chamber, a locating groove extending around an inside wall thereof within said accommodation open chamber, an inside flange protruded from the inside wall and disposed at a bottom side thereof in said accommodation open chamber and a grip disposed at a top side of the cap member, said lock screw comprising a stepped head fixedly fastened to said locating groove of said cap member, a shank perpendicularly extended from a flat bottom wall of said stepped head and inserted through said screw hole of said mounting base member and terminating in a threaded locking tip, said spring member being sleeved onto said shank of said lock screw and stopped between said stepped head of said lock screw and said partition wall of said mounting base member for enabling said lock screw to be moved axially in and out of said mounting base member to lock or unlock said second panel member.

2. The floating fastener as claimed in claim 1, wherein said upper chamber of said mounting base member has a greater diameter and shorter depth than said bottom chamber.

3. The floating fastener as claimed in claim 1, wherein said grip of said cap member is formed of two finger lugs respectively outwardly extended from a top edge thereof at two opposite sides.

4. The floating fastener as claimed in claim 1, wherein said grip of said cap member is formed of a broad brim extending around a top edge of the periphery of said cap member.
